(19) United States
(12) Patent Application Publication
(10) Pub. No.: US 2025/0222335 A1
(43) Pub. Date: Jul. 10, 2025

(54) DEVICE FOR POSITIONING AND ORIENTING TEE-OFF MARKINGS

(71) Applicant: Bernard REICHENPFADER, St. Wolfgang im Salzkammergut (AT)

(72) Inventor: Bernard REICHENPFADER, St. Wolfgang im Salzkammergut (AT)

(21) Appl. No.: 18/851,562

(22) PCT Filed: Dec. 5, 2022
(86) PCT No.: PCT/EP2022/084381

§ 371 Date: Sep. 26, 2024

(30) Foreign Application Priority Data
Mar. 29, 2022 (DE) 10 2022 107 352.1

(51) Int. Cl. A63B 71/06; A63B 69/36

(52) U.S. Cl. CPC A63B 71/0622; A63B 69/3691; A63B 2071/0694; A63B 2220/12; A63B 2220/62; A63B 2225/093; A63B 2225/66; A63B 2225/74

(57) ABSTRACT

Device for indicating marking positions on a ground surface of a golf course, which device is arranged facing the ground surface, wherein a plurality of beams of light rays are output by at least one light source, which beams of light rays are directed onto the ground surface from a high point spaced apart from the ground surface, wherein a plurality of patterns are projected on the ground surface by individual beams of light rays, wherein an individual beam of light rays characterizes an individual marking position by an individual pattern of the plurality of patterns, wherein each beam of light rays comprises a main axis, which main axis is oriented at an acute angle alpha, beta with respect to the ground surface and/or to a horizontal axis.

### CROSS-REFERENCE TO RELATED APPLICATIONS

The present application is a national phase application of PCT Application No. PCT/EP2022/084381, filed Dec. 5, 2022, entitled “DEVICE FOR POSITIONING AND ORIENTING TEE-OFF MARKINGS”, which claims the benefit of German Patent Application No. 10 2022 107 352.1, filed Mar. 29, 2022, each of which is incorporated by reference in its entirety.

### BACKGROUND OF THE INVENTION

### 1. Field of the Invention

The invention relates to a device for positioning and aligning tee-markers for displaying marking positions on a ground of a golf course.

### 2. Description of the Related Art

The invention discussed below relates to a device for displaying positions of tee-markers on a golf course surface. In the following, the position of a tee-marker displayed using the device according to the invention is briefly referred to as the marking position.

The teeing area is an area of a golf course from which a golfer starts his game at the beginning of a hole. The teeing area has the shape of a rectangle two club lengths deep, in which area the front edge is defined by the line between the forward-most points of two tee-markers set by the Committee. The area is defined by extending the lines from the outside points of the tee-markers two club lengths backwards.

In the context of the disclosure of the invention, a direction of play is defined as the direction in which the player hits the ball or in which direction the player hits or wants to hit the ball with an assumed probability.

The research has shown that a device is known from DE102005023510A1 that is intended to support the placement of tee-markers on golf courses. This is achieved by orienting this device in the direction of play and using lasers or poles to indicate the direction in which the tee-markers should be positioned. Laser beams or Poles are guided above the ground parallel to the ground, but this does not indicate a defined distance between the tee-markers. This is only possible with telescopic or removable rods with a defined length. Since the distance between the tee-markings is usually around four to six meters, the device can only be meaningfully transported between the teeing areas with the telescopic poles retracted or removed. This means that the rods would have to be readjusted for each teeing area, which results in inaccuracy. Aligning the tee-markers in the direction of play is not possible with this device. These are probably the reasons why this device is practically not used.

The device described in AT507753A1 can be assigned to golf, but is not used to prepare the course, but rather as a training device that records the parameters of the golf swing by measurements. The device uses lighting devices to mark the foot and ball position but is not suitable for positioning the tee-markers.

The documents DE 102007030989A1, DE29716316U1, DE102007039341A1, DE102007039342A1 and U.S. Pat. No. 3,936,197A describe devices that provide light or use laser beams but cannot be used to position the tee-markers as described.

U.S. Pat. No. 8,690,715 discloses a lighting device for projecting field markings onto a playing field. According to current teaching, such playing field markings as can be seen, for example, in FIG. 1 of U.S. Pat. No. 8,690,715 cannot be used to identify a clear position. For this reason, U.S. Pat. No. 8,690,715 should not be considered a document defining the state of the art.

U.S. Pat. No. 11,161,028 does not disclose a device for determining two points by guiding light beams from a high point to marking positions, the main axes of the light beams having similar or equal angles to the background or to a horizontal axis. In contrast to the patent application discussed below, the teaching of U.S. Pat. No. 11,161,028 is not limited to creating marking positions at the same or similar distances from the device.

US20080254920 discloses displaying field markings. Like U.S. Pat. No. 8,690,715, US20080254920 does not constitute any relevant state of the art for the device according to the invention.

W02016023051 reveals that a circle is projected onto the playing field. According to current teaching, a circle is unsuitable for clearly marking several individual marking positions on a playing field.

According to the state of the art, setting the tee-markers is a problem that has not been solved satisfactorily. The setting of the tee-markers is to a certain extent subject to the subjective feeling of the member of the Committee, which member usually assesses the individual positions of the tee-markers. The influence of the subjective feeling of the executing member of the Committee is due, among other things, to the fact that technical aids nowadays are being used to a very limited extent.

The invention is based on the challenge of positioning and, if necessary, aligning the tee-markings on golf courses with little effort and in an accurate and reproducible manner. The process of positioning the tee-markers should take as short time as possible.

### SUMMARY OF THE INVENTION

According to the invention, this is achieved thereby that several bundles of light rays are emitted by at least one light source, which bundles of light rays are directed onto the ground from a high point at a distance from the ground, with several patterns being projected onto the ground by individual bundles of light rays, whereby a single bundle of light rays indicates a single marking position by a single pattern of the plurality of patterns, each bundle of light rays comprising a main axis, which main axis is oriented at an acute angle to the ground and/or to an imaginary horizontal axis, in which marking position a tee-marker can be arranged.

The device according to the invention is preferably designed to be portable.

The at least one light source emits a bundle of light rays with a main axis, which main axis impinges on the ground. A marking is drawn by the bundle of light rays striking the surface, which markings define an impact point with sufficient precision. In contrast to the methods and devices according to the state of the art, the light beams are oriented at an acute angle to the ground. This allows the orientation and the distance of the marking position to the device, in particular to the high point, to be determined by the bundle of light rays. Likewise, multiple marking positions can be defined relative to one another by using multiple bundles of light beams. As a rule, with the device according to the invention two marking positions may be displayed for setting each tee-marker.

When viewing the device from above, the marking positions can be projected onto the ground adjacent to different sides of the device. In a preferred embodiment, when the device is viewed from above, the marking positions are projected onto the ground adjacent to opposite sides of the device. This is further explained below using figures.

The acute angle alpha, which angle alpha the first light beam has with respect to the ground, and the acute angle beta can be equal. This can be the case in particular with a flat and horizontally extending surface.

The angles alpha and beta can be different.

The device according to the invention can thereby be characterized that the marking positions are arranged adjacent to different sides of the device when the device is viewed on the ground.

The device according to the invention can thereby be characterized that the bundles of light rays are emitted in different directions when the device is viewed from above.

The projecting of the marking positions, which marking positions are projected onto the ground adjacent to different sides of the device when viewed from above, is done thereby that the main rays of the light rays are emitted by the device in different directions.

The device according to the invention can thereby be characterized that the marking positions are arranged on the ground adjacent to opposite sides of the device when the device is viewed.

The device according to the invention can be characterized in that the bundles of light rays are emitted in opposite directions when the device is viewed from above.

Projecting the marking positions onto opposite points of the ground when viewed from above can cause that the main rays of the device are emitted in opposite directions. Emitting the light beams in opposite directions results in the projection of marker positions to the left and right of the device.

The pattern can, for example and therefore not restrictively, have a dot shape or a cross shape or another shape known to those skilled in the art, which shape according to the state of the art allows a sufficiently precise identification of a point on a surface.

The pattern may also include directional information. When using the cross shape as a pattern, one leg of the cross can be designed with a longer leg length than the other leg lengths.

The bundle of light rays can be guided through a lens to display the point or the marking position. Furthermore, it is possible to display the point or the marking position using several bundles, which bundles together display a geometric shape such as a cross or a circle.

It is crucial here that a main axis of a bundle of light rays passes through a high point spaced from the ground, which light beam is directed onto the ground at an acute angle.

The main axes, which pass through high points that are essentially equally spaced from the ground in the vertical direction and arranged at a defined distance from one another, impinge on the high points at similar distances projected onto the ground. This is particularly the case if the ground is flat and extends horizontally.

In the sense of an equivalent or obvious embodiment of the device according to the invention, the person skilled in the art can compensate for different heights of the high points relative to the ground or a shape of the ground that deviates from the ideal case mentioned by different acute angles alpha and beta. Different heights of the high points can be caused, for example, by an inclined ground or by a curved ground.

The device according to the invention can be characterized in that the device comprises a measuring device for determining the vertical distance.

The device can comprise a first measuring device for determining a vertical first distance of a first height point from the ground and a second measuring device for determining a vertical second distance of a second high point from the ground. The acute angles alpha, beta can be selected depending on the vertical distances so that the distances between the respective high point projected onto the ground and the respective marking position are equal.

The device according to the invention can be characterized in that a light beam guiding element and/or light beam focusing element is arranged between the at least one light source and the ground, which light beam guiding element or which light beam focusing element the light beam passes through.

A light beam guiding element can, for example, be an element with a reflective surface. The direction of a light beam can be changed by the light beam guiding element. A light beam can also be divided by the light beam guiding element.

The device according to the invention can be based on the use of laser light. Those skilled in the art may also envisage the use of other types of light, which types of light may require the use of light beam focusing elements to indicate the marking position with sufficient light intensity.

The device according to the invention can comprise a single light source. The light beam emitted by the single light source can be divided using a beam splitter so that multiple marking positions can be displayed using a single light source.

The device according to the invention can thereby be characterized that a first light source emits a first bundle of light rays and a second light source emits a second bundle of light rays.

The use of a number of light sources to display a number of marking positions corresponding to this number can have the advantage that no light beams emitted by the light sources have to be divided. The intensity of the display of a marking position can be higher when using multiple light sources than when using a single light source to display multiple marker positions.

The device according to the invention can be characterized in that a single light source emits several bundles of light beams.

Providing a single light source has the disadvantage that the light beams emitted by the single light source must be divided to display multiple marking positions. This reduces the intensity of a marking position displayed on the ground compared to the use of multiple light sources.

The device according to the invention can be characterized in that the device comprises a sighting device such as a rear sight and front sight, a rod, a light beam or an optical sighting device, which sighting device allows the main axes to be aligned with the direction of play.

The device according to the invention can be characterized in that the sighting device is detachably or permanently arranged on the device.

The alignment devices mentioned here as examples are known to those skilled in the art. The person skilled in the art can also provide other alignment devices known in the art. Using the alignment device, the main axis projected onto the surface can be aligned with the direction of play. Typically, the main axis projected onto the ground is oriented at an angle of 90 degrees to the direction of play.

A sighting device such as a rear sight and front sight, a rod, a light beam or an optical sighting device has to be operated by a person. These embodiments of a sighting device are therefore subject to the accuracy of operation by the person.

The device according to the invention can be characterized in that the device comprises a position determination device, by means of which position determination device the position of the device and the orientation of the main axis of the light beam can be determined with respect to a coordinate system, the direction of play being defined in the coordinate system, so that the main axis of the light beam can be aligned with the direction of play. The position determination device can be, for example, a GPS system.

The device according to the invention can be used on a golf course. Preferably there are planning data about the golf course, which planning data are stored in a database. The planning data can be compared with data about the position of the device and orientation of the main beam. A direction of play for a position of the device and an orientation of the main axes can be calculated according to the rules of the game. The direction of play is calculated in relation to the coordinate system.

The device may include a display indicating a required change in the orientation of the main beam or the device. The user can adjust the main beam or the device as a whole according to this information. In addition, or as an alternative to this, alignment can also take place via a control device.

The device according to the invention can allow alignment of the individual main beams or a coupled alignment of several main beams. All main beams can be aligned by aligning the device that outputs all main beams.

It is mentioned above that the pattern used to identify the marker position includes a directional indication. Aligning the main axis is achieved by aligning the device according to the invention. Since light beams oriented by the main axis provide a defined pattern, the orientation of the direction indicated by the pattern can be achieved by aligning the device according to the invention.

The device according to the invention can thereby be characterized that the high point can be adjusted by a height adjustment device, whereby a marking position distance, which marking position distance is measured between two marking positions, can be changed by a vertical distance of the high point to the ground, which height adjustment device can be changed manually and/or is operable by a drive system.

By setting the high points at a constant acute angle, the distance projected onto the ground between the high point projected onto the ground and the marking position on the ground is changed.

The device according to the invention can thereby be characterized that the acute angle can be adjusted by an angle adjustment device, so that the marking position distance can be adjusted by changing the acute angle of a main axis, the angle adjustment device being operable manually and/or by a drive system.

By changing the acute angle, the distance projected onto the ground between the high point and the marking position is changed while the height of the high point remains unchanged.

The user can adjust the acute angle and/or the height of the high point in order to change the distance between the high point projected onto the ground and the marking position.

The ground can be a flat and horizontally extending surface. However, such a ground cannot be created in nature and therefore cannot be created on the golf course. The device disclosed here can thereby also be characterized that by adjusting the height of the high point and/or by adjusting the acute angle, a ground that deviates from the ideal shape is taken into account when displaying the marking positions. This may imply that the device according to the invention comprises measuring systems for recording the geometric shape of the ground. Furthermore, the device according to the invention can include a computing unit for calculating the acute angle and/or the height of the high point, taking into account the shape of the ground.

The device according to the invention can thereby be characterized that the device comprises a display device, on which display device a change or a value of the distance between the high point and the ground and/or a change or a value of the acute angle or the numerical value of the acute angle and/or the pattern spacing can be displayed on. The display device can display the information for manually setting the required adjusting device. Furthermore, the display device can display the information mentioned for documentation purposes.

The device according to the invention can thereby be characterized that a lighting duration of the at least one light source can be regulated by a time control unit.

The device according to the invention can thereby be characterized that the at least one light source, optionally the light beam guiding elements and optionally the light beam focusing elements are arranged on a carrier plate, which carrier plate is rotatable mounted in a lockable manner around at least one horizontal axis, so that the high points and the marking positions are arranged in a vertical plane, extending at an angle of 90 degrees to the direction of play.

A first horizontal axis can be arranged at an angle of 90 degrees to the direction of play and thus parallel to the main axis projected onto the ground. A second horizontal axis may be aligned at a 90 degree angle to the first horizontal axis.

The carrier plate can be mounted so that it can pivot freely about the first axis and/or about the second axis. A carrier plate, which carrier plate advantageously has its center of gravity below the at least one axis, is aligned by gravity. The carrier plate is therefore mounted on a gimbal.

This gravity orientation can be about one axis or about two axes, as is known in other state of the art devices. The device according to the invention can have locking means for blocking the rotational movement of the carrier plate about this axis or these axes. Furthermore, the mounting around the axis mentioned can also include damping and/or resistance. For example, a resistance prevents the carrier plate from being realigned by environmental influences such as wind. The device according to the invention can also thereby be characterized that the carrier plate is rigidly mounted to a further element such as a housing, which housing is rotatable mounted around at least one horizontal axis.

The device according to the invention can thereby be characterized that a laser output device serves as the at least one light source and the laser output device is cooled by a cooling medium.

According to current theory, a laser light is characterized by strong bundling and high intensity of the light. For this reason, the use of laser light in the device according to the invention is advantageous. The person skilled in the art can also provide other forms of light and cooling of the light source using a cooling medium.

The device according to the invention can thereby be characterized that the at least one light source and optionally the light beam guiding elements and optionally the light beam focusing elements are arranged in a housing, which housing comprises light outlet openings, which light outlet openings can be sealed with a transparent material.

The housing can be waterproof and/or airtight.

The device according to the invention can thereby be characterized that the device comprises at least one light source, which light source emits light with different colors, between which colors the user chooses.

Providing laser light beams with different colors makes it necessary to provide multiple laser light output devices. The device according to the invention can thereby be characterized that the respective laser light output device is also selected when the laser light to be emitted is selected.

### BRIEF DESCRIPTION OF THE DRAWINGS

The invention is further explained with reference to the following embodiments shown in the figures:

FIG. 1 shows the basic system for displaying the marking positions using the device according to the invention through a side view,

FIG. 2 also shows the basic system and the patterns projected onto the ground through a top view,

FIG. 3 is an orthogonal view of an embodiment of the device mounted on a photo or video tripod with a panning head,

FIG. 4 is an orthogonal opened view of the embodiment with gimbal mounting of the carrier with mounts for the light sources and the possibility of attaching non-contact vibration damping,

FIG. 5 is an orthogonal view of the embodiment with a gimbal suspension of the housing, with light sources mounted inside the housing either fixed or rotatable around a horizontal axis pointing in the direction of play,

FIG. 6 is a view of a carrier plate with light sources mounted rotatable about a horizontal axis pointing in the direction of play,

FIG. 7 shows a standardized mounting rail for a sighting device, which sighting device is used in other devices according to the state of the art.

### DETAILED DESCRIPTION

The embodiments shown in the Figures only show possible embodiments, although it should be noted at this point that the invention is not limited to these specifically illustrated embodiment variants, but combinations of the individual embodiment variants with one another and a combination of an embodiment with the general description given above are also possible. These other possible combinations do not have to be explicitly mentioned, since these other possible combinations are within the ability of the person skilled in the art working in this technical field due to the teaching on technical action by the present invention.

The scope of protection is determined by the claims. However, the description and drawings must be used to interpret the claims. Individual features or combinations of features from the different embodiments shown and described can represent independent inventive solutions in their own right. The task underlying the independent inventive solutions can be found in the description.

In the Figures, the following elements are identified by the preceding reference numerals:
1 ground
2 first light source
3 second light source
4 first ray of light
5 second ray of light
6 device according to the invention
7 first high point
8 second high point
9 first marking position
10 second marking position
11 first distance projected onto the ground
12 second distance projected onto the ground
13 stand
14 marking position distance
15 carrier plate
16 axis
17 direction of play
18 vertical plane
19 alignment line
20 sighting device
21 another vertical beam of light
22 position vertically below the device
23 another inclined beam of light
24 light source for light beam 23
25 locking means
26 third light source for the light beam 21
27 direction point

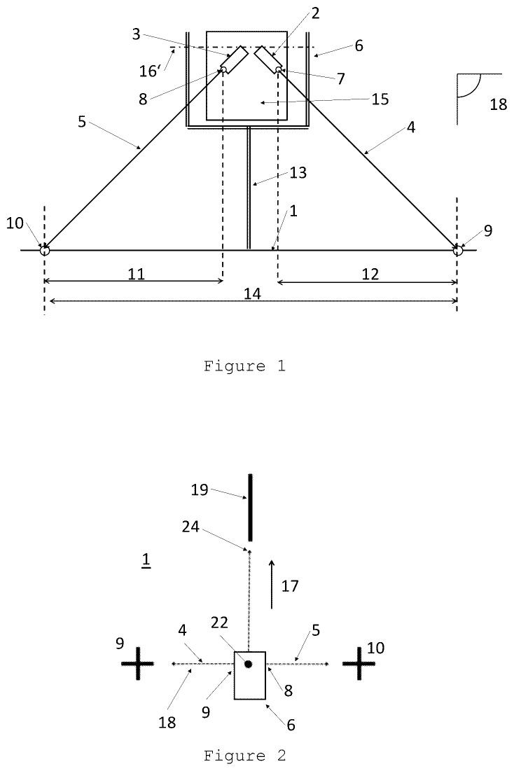

FIG. 1 uses a sectional view with a vertical sectional plane to illustrate the system for displaying marking positions, which display system can be implemented with the device according to the invention. The device 6 according to the invention is used to display marking positions 9, 10 on a surface 1 of a golf course, wherein the device 6 according to the invention is arranged on the ground 1. The ground 1 can ideally be a flat and horizontally extending plane, as shown schematically in FIG. 1.

The device 6 according to the invention is used in particular to display marking positions 9, 10 to the left and right of the device 6, looking, for example, in a playing direction 17 described below. The device is arranged between the marking points 9, 10. This arrangement of the device essentially corresponds to the position of the member of the Committee, who, according to common teaching, defines the marking position to his left and right.

The device 6 comprises a first light source 2, which first light source 2 emits a first light beam 4. Furthermore, the device 6 comprises a second light source 3, which second light source 3 emits a second light beam 5.

In the Figures, a bundle of light rays is shown in a simplified manner as a light ray 4, 5, in particular as the main axis of the light rays, and is also described as such in the description of the figures. The term “ray of light” used in the description of the figures can also be understood as a bundle of light rays.

A bundle of light rays 4, 5 has a cross section that extends exclusively to the size of the marking position 9, 10.

The light beams 4, 5 are each directed onto the ground 1 from a high point 7, 8 defined by the light sources 2, 3. The light rays 4, 5 pass through the respective high point 7, 8; It is not mandatory that at least one light source 2, 3 forms the respective high point 7, 8. The person skilled in the art will recognize that the high point 7, 8 can also be defined by a light beam guiding element, not shown in FIG. 1.

By orienting the light sources 2, 3 or by setting up light beam guiding elements (not shown in FIG. 1), the respective light beam 4, 5 is directed onto the ground 1.

A pattern is projected onto the ground 1 by a light beam 4, 5. The pattern has a geometric shape which is suitable for identifying a clear The pattern may include, for example and not limitation, a dot shape or a cross shape. The pattern preferably does not have a surface area that exceeds the floor plan of a tee-marker or a projection area of a wall holding the tee-marker.

Furthermore, the expert uses a light beam 4, 5 with sufficient intensity so that the pattern on the ground 1 is clearly visible.

The user can arrange a tee-marker, not shown in FIG. 1, at the marking position 9, 10.

The embodiment sketched in FIG. 1 relates to the special form in which the marking positions 9, 10 are arranged adjacent to different sides, in particular to opposite sides of the device 6. Marking positions 9, 10 arranged to the left and right of the device according to the invention are thus generated using the device 6 according to the invention.

With the same height position of the high points 7, 8 and with the same angles alpha and beta, the distances projected onto the ground 1 between the high points 7, 8 and the marking positions 9, 10 are the same. A device 6 standing on a stand 13 on the surface 1 has a defined distance from the ground 1.

The high point 7, 8 is spaced from the ground 1. The light sources 2, 3 are aligned so that the main axis of the bundle of light rays, shown in FIG. 1 as a light beam 4, 5, encloses an acute angle alpha, beta to the ground 1.

Viewed in the direction of a light beam 4, 5, a light beam guiding element and/or light beam focusing element can be arranged between the light source 2, 3 and the ground 1. FIG. 1 does not show these elements. A light beam guiding element can, for example, allow the light source 2, 3 to emit the light beam in a direction other than the direction shown in FIG. 1 and for the light beam 4, 5 to be directed onto the ground 1 by means of the light beam guiding element.

The device 6 according to the invention, shown schematically in FIG. 1, is thereby characterized that the first light source 2 emits a first light beam 4 and the second light source 3 emits a second light beam 5. Alternatively, it is conceivable that a single light source is used and the two light beams are generated via a light splitter. Likewise, a single light source that emits two beams of light can be used.

The device 6 according to the invention can thereby be characterized that the high point 7, 8 can be adjusted by a height adjustment device, whereby a marking position distance 14, which marking position distance 14 is measured between two marking positions 9, 10, can be changed via a vertical distance of the device from the ground 1, which height adjustment device can be operated manually and/or by a drive system. In the embodiment shown in FIG. 1, the length of the stand 13 is adjustable. The person skilled in the art knows other options for adjusting the height of the light sources 2, 3.

The stand 13 of the embodiment shown in FIG. 1 can be rammed into the ground, whereby a hole in the ground 1 can be created. Such a hole can be viewed as a mark of the position of the device 6, which mark allows the device 6 to be set up repeatedly at this position.

The device 6 according to the invention can further be characterized in that the output direction of the light beam 4, 5 described by the acute angle alpha, beta can be adjusted by an angle adjustment device, so that the pattern distance can be adjusted by changing the acute angle of a main axis, the angle adjustment device being manual and/or can be actuated by a drive system.

The user can combine the adjustment devices mentioned in an advantageous manner.

The device 6 according to the invention can thereby further be characterized that the light sources 2, 3 are arranged on a carrier plate 15, which carrier plate 15 is mounted so that it can be locked and rotated about at least one horizontal axis 16′, so that the high points 7, 8 and the marking positions 9, 10 are arranged in a plane 18 extending vertically, at an angle of 90 degrees to the direction of play 17.

FIG. 2 shows a view from above on the ground 1, which view includes, among other things, the markings 9, 10, 22 projected onto the ground 1.

The marking positions 9, 10 and the high points 7, 8 are arranged in a vertically extending plane 18, which vertical plane 18 is shown in FIG. 2 as a line representing the floor plan of the plane 18. Furthermore, the light beams 4, 5 and the axis 16′ extend in this plane 18.

In the view shown from above, the marking positions 9, 10 are arranged adjacent to opposite sides of the device 6. The light beams 4, 5, in particular the horizontal component of the light beams 4, 5, are emitted in opposite directions. Marking positions 9, 10 arranged on the left and right of the device and on the ground are thus created.

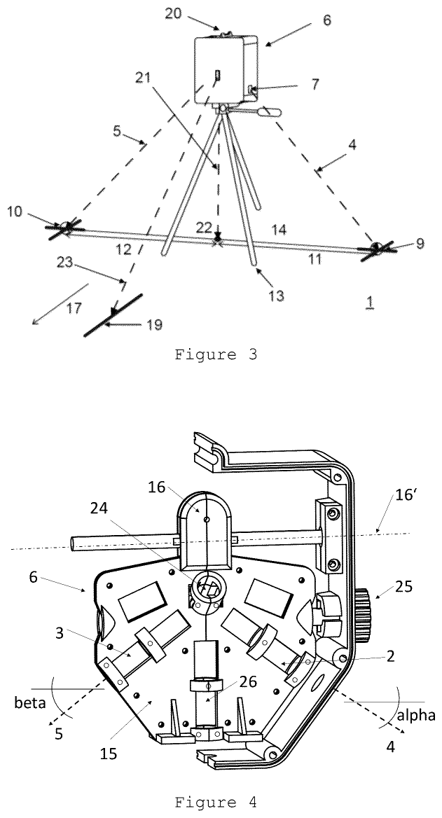

The point 22 serves to identify the position of the device 6 on the ground. The point 22 can be generated by a further vertically aligned light beam 21 projected vertically onto the ground by the device 6, as can be seen in FIG. 3 The user can mark point 22 on the surface.

In a preferred application, the vertical plane 18 is arranged at an angle of 90 degrees to a direction of play 17. The device can include a sighting device 20, which sighting device 20 allows it to be aligned in the direction of play 17 and thus to align the plane 18 at an angle of 90 degrees to the direction of play 17.

The direction of play 17 can include at least one horizontal component, to which horizontal component the plane 18 can be aligned at an angle of 90 degrees.

FIG. 3 shows a three-dimensional view of a possible embodiment of the device 6 according to the invention. The device shown in FIG. 3 can be the device shown in FIG. 2.

The portable device 6 is mounted on three stands 13. Such stands 13 are known, for example, for mounting cameras and allow lockable height adjustment and/or inclination adjustment of the device 6. The inclination adjustment of the device 6 can, as described above, take place as an inclination of the device 6 about one axis or two axes, which axis or axes are not shown in FIG. 3.

The device 6 can be adjusted in height and/or in its inclination to the ground 1 via the tripod comprising the stands 13. This ensures that the light beams 4, 5 are projected onto the ground 1 to mark marking positions 9, 10, so that tee-markers (not shown in FIG. 3) can be set at the marking positions 9, 10.

The embodiment shown in FIG. 3 comprises an optical sighting device 20, the invention disclosed here being in no way limited to optical sighting devices for aligning the device 6 in the direction of play 17. The person skilled in the art can also provide other devices for aligning the device 6 according to the invention.

The device 6 according to the invention can include a further output unit for outputting a further vertical light beam 21 for marking the point 22. The point 22 can serve to identify the position of the devices 6 according to the invention after the device 6 according to the invention has been moved. The use of the tripod with three supports advantageously allows the output of the further vertical light beam 21 for projecting the point 22 onto the ground 1.

The device 6 according to the invention can include a further output unit for outputting a further inclined light beam 23. The projection of the further inclined light beam 23 onto the ground 1 creates an alignment line 19 displayed on the ground 1. The device 6 can be aligned using the alignment line 19 as an alternative or in addition to the sighting device mentioned. The user can compare the orientation of the alignment line 19 with an imaginary direction of play 17 and, if necessary, change the orientation or location of the device 6.

A consistent height adjustment and inclination alignment can be achieved by a locking means. The tripod shown in FIG. 3 includes such a locking means.

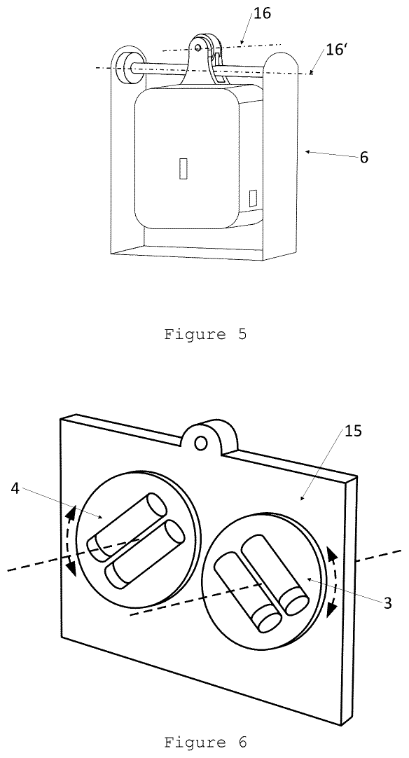

FIG. 4 shows an embodiment of the device 6 according to the invention in a partially opened and in an open state. The device 6 according to the invention comprises a carrier plate 15, on which carrier plate 15 a first light source 2 for emitting a first light beam 4 is aligned at an acute angle alpha. The angle alpha is measured between the first light beam 4 and a horizontal. The horizontal can be parallel to the ground 1. The carrier plate 15 is gimbal-mounted to the axes 16, 16′ and thus aligns itself by gravity. The device 6 can include locking means 25 for locking at least one degree of freedom.

The carrier plate 15 further comprises a third light source 26 for outputting the above-described light beam 21 and/or the light beam 23.

FIG. 5 shows the embodiment shown in FIG. 4 in a closed view. The axes 16, 16′ are external so that the user can observe alignment around these axes 16, 16′.

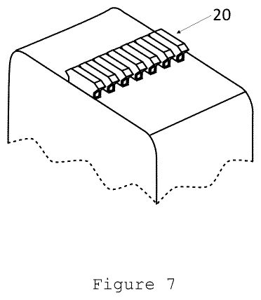

FIG. 6 shows a possible embodiment of a mounting of light sources 3, 4 on the carrier plate 15. To set the acute angle alpha, beta, the light sources 3, 4 are mounted rotatable about an axis, which axis is oriented at an angle of 90 degrees to the surface of the carrier plate 15.

FIG. 7 shows a standardized mounting rail for a sighting device according to the state of the art, which mounting rail is used in other devices.

1-19. (canceled)

20. A device for positioning and aligning tee-markers for displaying marking positions on a ground of a golf course, the device being arranged on the ground, comprising:
at least one light source configured to emit a plurality of bundles of light beams, the plurality of bundles of light beams being directed onto the ground from a high point spaced from the ground, which individual bundles of light rays project a plurality of patterns onto the ground, with a single bundle of light rays identifying a single marking position by a single pattern of the plurality of patterns;
wherein each bundle of light beams comprises a main axis, the main axis being oriented at an acute angle to at least one of the ground and the horizontal axis, the marking position being for a tee-marker.

21. The device according to claim 20, wherein a first acute angle of a first main axis and a second acute angle of a second main axis have a same magnitude.

22. The device according to claim 20, wherein the marking positions are arranged on the ground adjacent to different sides of the device.

23. The device according to claim 20, wherein the bundles of light rays are emitted in different directions.

24. The device according to claim 22, wherein the marking positions are arranged on the ground adjacent to opposite sides of the device.

25. The device according to claim 23, wherein the bundles of light rays are emitted in opposite directions.

26. The device according to claim 20, wherein at least one of a light beam guiding element and a light beam focusing element is arranged between the at least one light source and the ground, at least one of the light beams configured to pass through the at least one of the light beam guiding element and the light beam focusing element.

27. The device according to claim 20, wherein a first light source is configured to emit a first bundle of first light rays and a second light source is configured to emit a second bundle of second light rays.

28. The device according to claim 20, wherein a single light source is configured to emit several bundles of light beams.

29. The device according to claim 20, further comprising a sighting device fixedly or detachably arranged on the device for aligning the main axis of the light beam to a direction of play.

30. The device according to claim 20, further comprising a position determination device, the position determination device configured to determine a position of the device for positioning and aligning tee-markers and an orientation of the main axis of the light beam with respect to a coordinate system;
wherein a direction of play is defined in the coordinate system, the main axis of the light beam being aligned with the direction of play.

31. The device according to claim 20, wherein the pattern comprises a direction indication parallel to a direction of play.

32. The device according to claim 20, further comprising a height adjusting device configured to adjust a distance between the ground and at least one of:
the at least one light source;
a light beam guiding element; and
a light beam focusing element;
wherein the height adjusting device is configured to adjust a marking position distance measured between the marking positions by changing a vertical distance of the device for positioning and aligning tee-markers to the ground; and
wherein the height adjusting device is configured to be operated at least one of manually and by a drive system.

33. The device according to claim 20, further comprising an angle adjusting device configured to adjust the acute angle, the angle adjusting device being operable at least one of manually and by a drive, a marking position distance being adjustable by changing the acute angle of a main axis of the light beam.

34. The device according to claim 20, further comprising a display configured to display at least one of:
a change or a value of the distance between the high point and the ground;
a change or a value of the acute angle;
a numerical value of the acute angle; and
a marking position distance.

35. The device according to claim 20, wherein a lighting duration of the at least one light source is configured to be regulated by a time control unit.

36. The device according to claim 20, wherein the at least one light source is arranged on a carrier plate, the carrier plate being rotatably mounted in a lockable manner around at least one horizontal axis, so that the high points and the marking positions are arranged in a plane extending vertically, at an angle of 90 degrees to a direction of play.

37. The device according to claim 20, wherein the at least one light source is cooled by a cooling medium.

38. The device according to claim 20, wherein the at least one light source is arranged in a housing, the housing comprising light outlet openings made of a transparent material or recesses.

39. The device according to claim 20, wherein the at least one light source is configured to emit light with a plurality of colors, the plurality of colors being selectable by a user.
